(19) United States
(12) Patent Application Publication
(10) Pub. No.: US 2018/0219395 A1
(43) Pub. Date: Aug. 2, 2018

(54) COLLAPSIBLE BATTERY CHARGER (CBC)

(71) Applicant: ALEXANDER CORCORAN KREMBS, HONG KONG (HK)

(72) Inventor: ALEXANDER CORCORAN KREMBS, HONG KONG (HK)

(21) Appl. No.: 15/857,641

(22) Filed: Dec. 29, 2017

Related U.S. Application Data
(60) Provisional application No. 62/441,996, filed on Jan. 4, 2017.

(51) Int. Cl. H02J 7/00

(52) U.S. Cl. CPC H02J 7/0042

(57) ABSTRACT

The Collapsible Battery Charger (CBC) is made of a plastic and metal housing, which can be assembled to hold common type “AA”, type “AAA” (TEC LRO3 or R03) or 9V batteries, when assembled can be used to charge an external device, such as a phone or smartphone, electronic tablet, laptop computer, or any other electric device.

### DETAILED DESCRIPTION OF THE INVENTION

Collapsible housing made from metal, plastic, or other material which can house batteries.

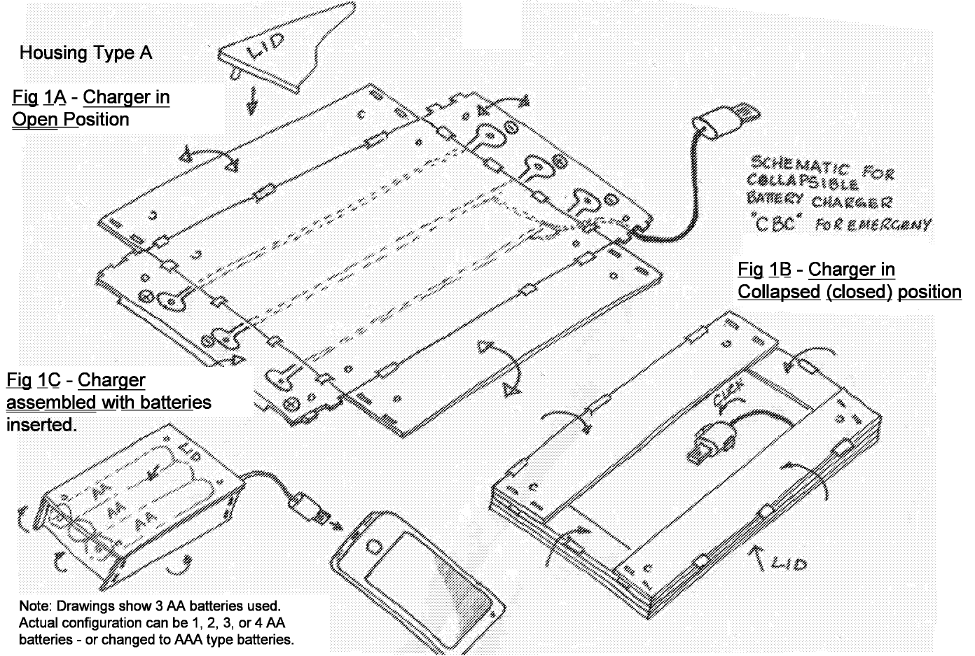

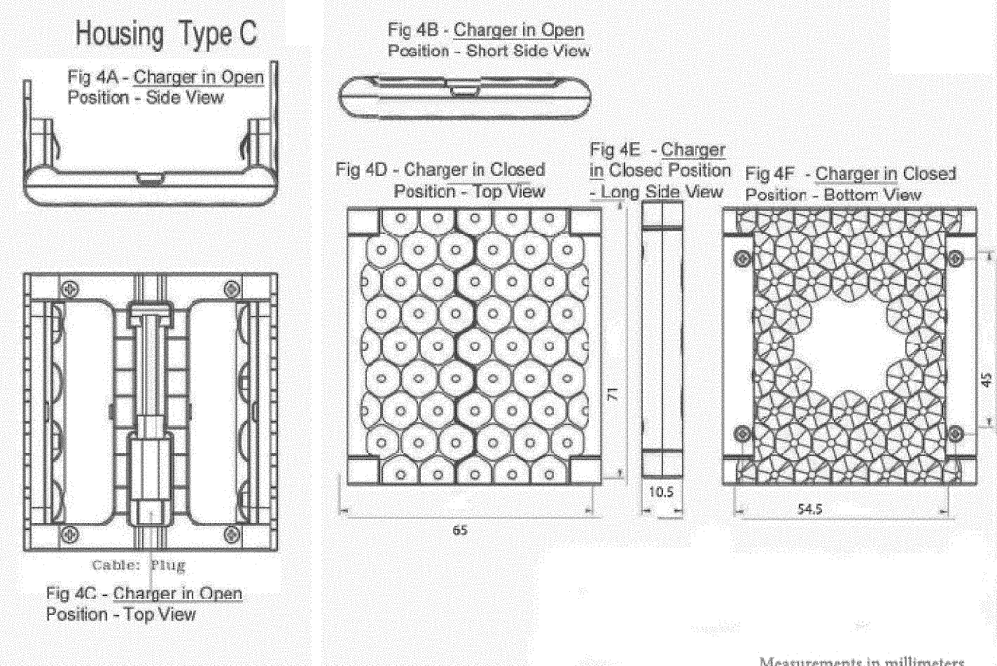

Housing can fold down into a flat, compact, portable shape when the batteries have been removed from the housing. See drawings of Housing Type A (FIG. 1A-1C) and Housing Type B (2A-2C) and Housing Type C (FIG. 4A-4F) for current configurations of collapsibility. All are similar to a credit card shape—and a meant to fit easily into a wallet, pocket, business card holder, purse, briefcase, backpack, or carry bag.

When the housing is assembled, and batteries have been inserted, the device becomes a power bank, power storage device, which can be used to: charge a phone or a smartphone, charge a tablet, charge a laptop computer, or any other electronic device.

The CBC can be connected to external devices via commonly accepted methods including cable with USB (any size, or type), any type of AC jack/plug, any type of DC jack/plug, or proprietary connectors such as the Iphone 5 lightning connector, or other connectors not yet known which can provide power to the external device.

The types of batteries designed for the CBC device are:
a. Type “AA”—also known by IEC #LR6 (alkaline), R6 (carbon-zinc)
b. Type “AAA”—also known by IEC #LR03 (alkaline), R03 (carbon-zinc)
c. Type “9V” or “E”—also known by IEC #6LR61 (alkaline), 6F22 (carbon-zinc)

The CBC has a circuit (as required) which allows for the battery power to be converted to a usable format of the intended device to be charged.

The CBC may have the option of a recharging circuit (as required) which allows the batteries to be recharge—when used with batteries specified for recharging.

The CBC may have a display which indicates the level of power stored in the batteries, and its charging progress.

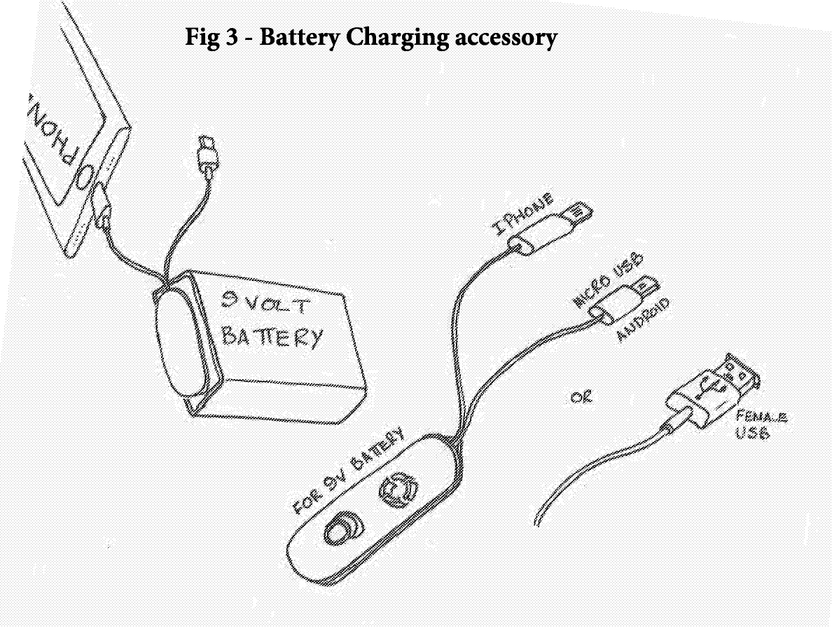

The CBC may have an optional accessory included which will connect a 9V battery see FIG. 3 in drawings.

### BRIEF DESCRIPTION OF THE DRAWING

Drawing 1—Housing Type A—FIG. 1A—Charger in Open Position, FIG. 1B—Charger in Collapsed Position, FIG. 1C—Charger assembled with batteries inserted.

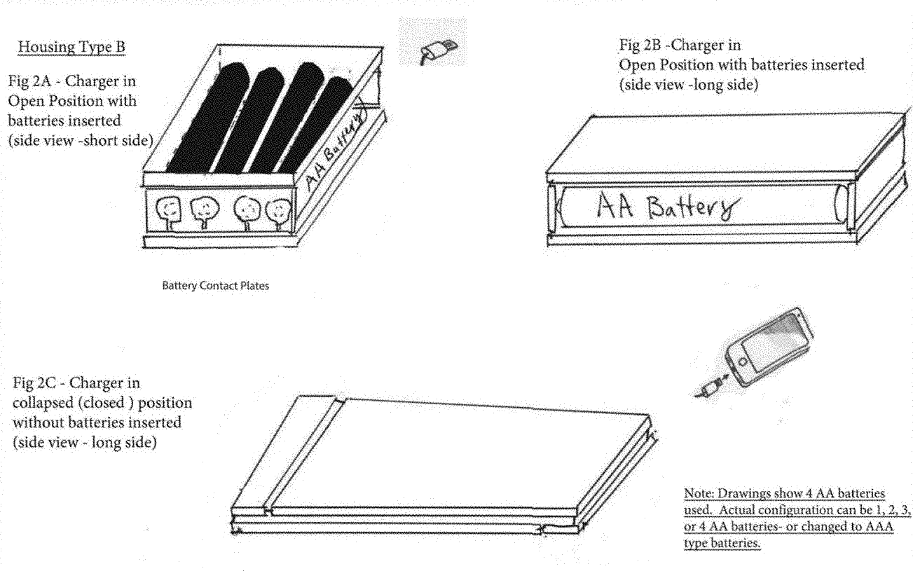

Drawing 2—Housing Type B—FIG. 2A—Charger in Open Position with batteries inserted (side view short side), FIG. 2B—Charger in Open Position with batteries inserted (side view—long side), FIG. 2C—Charger in collapsed position without batteries (side view—long side).

Drawing 3—FIG. 3—Battery Charging accessory

Drawing 4—FIG. 4A—Charger in Open Position—Side View, FIG. 4B—Charger in Open Position—Short Side View, FIG. 4C—Charger in Open Position—Top View, FIG. 4D Charger in Closed Position—Top View, FIG. 4E Charger in a Closed Position—Side Long View, FIG. 4F—Charger in a Closed Position—Bottom View.

Applications include but not limited to battery charging of:

1.1/ Portable consumer electronic devices including
Notebook computers,
Laptops,
Tablets,
Phones,
Smartphones.

1.2/ Any handheld device, which uses a rechargeable battery.

1.3/ Any device not yet invented which the safety can be aided by this CBC which cannot yet be foreseen in the existing technological base, but to which this CBC could apply.
Battery Types—The CBC could apply to any battery type—but is specifically designed for battery types
a. Type “AA”—also known by IEC #LR6 (alkaline), R6 (carbon-zinc)
b. Type “AAA”—also known by IEC #LR03 (alkaline), R03 (carbon-zinc)
c. Type “9V” or “E”—also known by IEC #6LR61 (alkaline), 6F22 (carbon-zinc)
Any battery device not known to the inventor, or not yet invented, which the safety can be aided by this CBC which cannot yet be foreseen in the existing technological base, but to which this CBC could apply.
Invention Claim of Unique and Exclusive utility is the application of CBC as a fully collapsible or foldable housing when batteries are removed.
